(19) United States
(12) Patent Application Publication
(10) Pub. No.: US 2004/0048969 A1
(43) Pub. Date: Mar. 11, 2004

(54) Method for producing an aqueous polymer dispersion by means of radically initiated aqueous emulsion polymerisation

(76) Inventors: Stefan Kirsch, Heidesheim (DE); Andreas Keller, Bohl-Iggelheim (DE); Martin Meister, Neustadt (DE); Chung-Ji Tschang, Bad Durkheim (DE); Steffen Funkhauser, Viernheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,106

(22) PCT Filed: Jan. 23, 2002
(86) PCT No.: PCT/EP02/00616

(30) Foreign Application Priority Data
Jan. 26, 2001 (DE) 101 03 709.0

(51) Int. Cl. C08K 3/20

(52) U.S. Cl. 524/457

(57) ABSTRACT

The invention relates to a method for producing an aqueous polymer dispersion by means of radically initiated aqueous emulsion polymerisation of at least one ethylenically unsaturated monomer in a polymerisation container comprising an external circuit leading away from said polymerisation container and back thereto.

The present invention relates to a process for the production of an aqueous polymer dispersion by aqueous free-radical emulsion polymerization of at least one ethylenically unsaturated compound (monomer) in a polymerization vessel which has an external loop leading from, and back to, the polymerization vessel, wherein

a) some or all of the water is placed in the polymerization vessel as initial batch,

b) the fluid medium present in the polymerization vessel is transported away from the polymerization vessel and recycled thereto through the external loop during polymerization and

c) at least a portion of at least one monomer is metered into the fluid medium that is transported through the external loop during polymerization.

The invention also relates to the aqueous polymer dispersions produced by the process and to the use thereof and to equipment for carrying out the process.

Aqueous free-radical emulsion polymerizations of monomers are carried out on an industrial scale in polymerization vessels having capacities of up to 60 m³. The monomers are directly fed to the reaction mixture present in the polymerization vessel, and the fluid reaction mixture must be cooled during the polymerization reaction to maintain the reaction temperature at a constant level. Cooling is usually effected by cooling the reaction vessel itself, for example, by causing the coolant to flow around the reaction vessel in a double jacket and/or by means of cooling coils present in the reaction vessel, through which the coolant passes. A drawback of this method is that the heat-exchanging surfaces and thus the reaction rates that can be obtained are restricted, for which reason cooling in so-called external heat exchangers is being used to an increasing extent.

For example, EP-A 486,262 discloses the manufacture of aqueous polymer dispersions, in which energy-balance control measures serve to control the feed of the ethylenically unsaturated monomers and the temperature. To effect temperature control, use is made of, inter alia, an external heat exchanger.

EP-A 608,567 also describes the use of cooling by means of external heat exchangers for the production of homopolymers or copolymers of vinyl chloride by the method of aqueous suspension polymerization.

EP-A 834,518 describes a process for the production of homopolymers and copolymers by the method of aqueous free-radical emulsion polymerization, in which an external heat exchanger is again used to effect cooling.

In the case of the hitherto known processes, the monomers are directly fed to the reaction mixture in the polymerization vessel, with stirring. This involves the continuous passage of fluid reaction mixture through an external circuit of pipes away from the polymerization vessel and, after passing through a heat exchanger, back to the polymerization vessel. A disadvantage of this method is that polymer deposits can occur on those metallic surfaces of the polymerization vessel, baffles therein, pipes, and the heat exchanger which come into contact with the aqueous polymer dispersion, and shear-induced coagulate may occur on account of the high stirring energy required for mixing. Polymer deposits on the metallic surfaces reduce the possible heat transfer to the internal and external heating and/or cooling elements and consequently the efficiency of such elements. Production must be interrupted at intervals to allow for cleaning of the metallic surfaces. In addition, polymer can strip off from the metallic surfaces and, like the shear-induced coagulate, form undesirable impurities in the aqueous polymer dispersions.

It is an object of the present invention to provide a process for the production of an aqueous polymer dispersion by aqueous free-radical emulsion polymerization employing an external loop, which process reduces the formation of deposits on metallic surfaces of the polymerization vessel, baffles therein, pipes, and the heat exchanger, and/or reduces coagulation.

Accordingly, we have found the aforementioned process for the production of an aqueous polymer dispersion by aqueous free-radical emulsion polymerization, the aqueous polymer dispersions produced by this process and the use thereof, and also equipment for carrying out the process.

Aqueous polymer dispersions are well known. They are fluid systems containing, as disperse phase in an aqueous dispersion medium, dispersed polymer coils consisting of a number of entangled polymer chains, these coils being the so-called polymer matrix or polymer particles. The diameter of the polymer particle is frequently in the range of from 10 to 5000 nm. Aqueous polymer dispersions are used in a large number of industrial applications as binding agents, for example, in paints or plasters, in sizes for leather, paper or plastics films, and as components of adhesives.

Aqueous polymer dispersions are obtained, in particular, by aqueous free-radical emulsion polymerization of monomers. This procedure has been described in many places and is therefore adequately known to the person skilled in the art [cf, eg, Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2^{nd} Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerization, pages 1 to 287, Academic Press, 1982; F. Hoelscher, Dispersionen synthetischer Hochpolymerer, pages 1 to 160, Springer-Verlag, Berlin, 1969 and patent specification DE-A 4,003,422]. Aqueous free-radical emulsion polymerization is usually carried out such that the monomers, frequently together with dispersants, are dispersed in an aqueous medium and polymerized by means of at least one free-radical polymerization initiator. Frequently, the residual contents of unconverted monomers in the resulting aqueous polymer dispersions are reduced by chemical and/or physical methods also known to the person skilled in the art [cf, for example, EP-A 771,328, DE-A 19624299, DE-A 19621027, DE-A 19741184, DE-A 19741187, DE-A 19805122, DE-A 19828183, DE-A 19839199, DE-A 19840586 and 19847115], and the content of solid polymer is adjusted to a desired level by dilution or concentration, or the aqueous polymer dispersion is supplemented by conventional additives, such as bacteriocidal or foam-inhibiting additives.

The process of the invention is carried out in a contrivance comprising

a polymerization vessel,

a contrivance I which enables fluid medium to be withdrawn from the polymerization vessel and recycled thereto at a point of entry which differs from the point of withdrawal and

a contrivance II which enables at least one monomer to be introduced into the fluid medium present in contrivance I,

In the present invention, some or all of the water that is required for the production of the aqueous polymer dispersion is placed in the polymerization vessel as initial batch. Any residual amount can be fed to the polymerization vessel during the polymerization reaction, for example, directly or in the form of an aqueous monomer emulsion.

In addition to the water, some or all of a dispersant, a seed latex, a free radical initiator, and/or a portion of at least one monomer may be placed in the polymerization vessel to form the initial batch.

The fluid contents of the reaction vessel are then brought to the reaction temperature and transported away from the polymerization vessel and recycled thereto through contrivance I forming an external loop. The external loop usually consists of a rigid or flexible conduit in which a pump is integrated. The point of withdrawal of the fluid medium is usually located in the lower third or fourth of its volume, preferably in the lower eighth or tenth of its volume, and more preferably at the bottom of the polymerization vessel. It is essential, however, that the point of withdrawal is disposed, at the commencement of the polymerization reaction, below the liquid level [liquid/gas interface] of the fluid reaction medium. Flowback of the fluid medium into the polymerization vessel can take place upwardly, laterally, or downwardly, as desired. However, it is essential that the point at which the fluid reaction mixture is recirculated into the reaction vessel differs from the point of withdrawal. In addition to the external loop, the polymerization vessel is equipped with conventional inlet and outlet conduits, heating, cooling, measuring, and regulating means, and a stirrer, for example, an anchor, blade, or MIG stirrer.

The rigid or flexible conduits and the pump in the external loop are dimensioned in a manner known to the person skilled in the art such that at least half of the internal volume of the polymerization vessel can be pumped over per hour. It is advantageous when at least a volume corresponding to the internal volume or 1.5 times or double the internal volume of the polymerization vessel can be pumped over per hour.

The type of pump used is not critical so that, for example, non-chokable pumps, impeller-type pumps, disc-flow pumps, rotating piston pumps, eccentric single-rotor screw pumps, cylindrical diaphragm pumps, etc. can be used. It is also of no critical importance whether the fluid reaction medium is pumped in laminar or turbulent flow.

In the present invention, there is passed through the external loop, per hour, a volume of fluid medium corresponding to half the internal volume, the internal volume itself, or 1.5 times or double the internal volume of the polymerization vessel and all values in between.

Polymerization is initiated by starting the reaction, at the reaction temperature, of at least a portion of at least one monomer and a free radical initiator in the polymerization vessel in aqueous medium.

It is essential for the success of the process that, during polymerization, at least a portion of at least one monomer is metered into the fluid medium that is transported through the external loop, via a contrivance II. Contrivance II usually comprises one or more metering pipes or nozzles. The feed of at least one monomer can take place batchwise or together with a continuous or discontinuous stream. In addition, the said monomer can be metered into the fluid medium in a pure state or in the form of an aqueous monomer emulsion. Preferably, an aqueous monomer emulsion is used.

If two or more monomers are used for polymerization, these can be fed to the fluid medium in a pure state or in the form of aqueous monomer emulsions via separate metering pipes or nozzles or, following premixing, via common metering means.

Into the fluid medium that is transported through the external loop there is metered in at least a portion of at least one monomer, but frequently all of said monomer, or the amount of the total monomer remaining after introduction of the portion thereof used as initial batch in the polymerization vessel before commencement of polymerization. Often, said monomer is metered into the fluid medium transported through the external loop in proportions of ≧50 wt %, ≧60 wt %, ≧70 wt %, ≧80 wt % or ≧90 wt % and all values between said values.

The partial amount of monomer used as initial batch in the polymerization vessel is usually ≦10 wt %, ≦5 wt %, or ≦2 wt %, always based on the total amount of monomer used for polymerization.

It should be noted that, during polymerization, a portion of at least one monomer may, if desired, be introduced directly into the reaction vessel in a pure state or in the form of an aqueous monomer emulsion. That portion of at least one monomer that is introduced directly into the reaction vessel is usually less than 50 wt %, based on the total amount thereof, or is equal to the amount of the total monomer remaining after placement of the portion used as initial batch in the polymerization vessel before commencement of polymerization. Alternatively, amounts of ≦40 wt %, ≦30 wt %, ≦20 wt %, or ≦10 wt % of the previously mentioned amounts of at least one monomer can be introduced directly into the polymerization vessel during polymerization. Preferably, however, there is no direct monomer feed into the polymerization vessel.

Said monomer(s) can be metered into the fluid medium at theoretically any point along the external loop. The necessary measuring and controlling measures are familiar to the person skilled in the art. It is advantageous when said monomer is introduced into the fluid medium at a point between the point of withdrawal from the reaction vessel and the suction side of the pump in the external loop. It is particularly advantageous when the point at which the monomer is metered in is positioned near said point of withdrawal.

The said introduced monomer(s) are well mixed with the pumped fluid medium by use of dynamic and/or static mixing means integrated in the external loop and known to the person skilled in the art. Preferably, these mixing means are installed in the external loop between the metering point and the pump.

The external loop can also contain one or more commercial heat exchangers, such as plate air heaters, shell-and-tube heat exchangers, or spiral-plate heat exchangers, as well as other fixtures.

Particularly suitable monomer(s) for use in the synthesis of the aqueous polymer dispersions are ethylenically unsaturated compounds that are capable of undergoing-simple free-radical polymerization, such as ethylene, vinylaromatic monomers, such as styrene, α-methylstyrene, o-chlorostyrene, or vinyl toluenes, vinyl halides, such as vinyl chloride or vinylidene chloride, esters of vinyl alcohol with monocarboxylic acids containing from 1 to 18 carbons, such as vinyl acetate, vinyl propionate, vinyl-n-butyrate, vinyl laurate, and vinyl stearate, esters of α,β-mono-ethylenically unsaturated mono- and di-carboxylic acids containing preferably from 3 to 6 carbons, such as, in particular, acrylic acid, methacrylic acid, maleic acid, fumaric acid, and itaconic acid, with alkanols generally containing from 1 to 12, preferably from 1 to 8 and more preferably from 1 to 4 carbon atoms, such as, in particular, methyl, ethyl, n-butyl, isobutyl, pentyl, hexyl, heptyl, octyl, nonyl, decyl, and 2-ethylhexyl (meth)acrylates, dimethyl or di-n-butyl fumarates and maleates, nitriles of α,β-monoethylenically unsaturated carboxylic acids, such as acrylonitrile, methacrylonitrile, fumarodinitrile, maleinodinitril, and also C₄-C₈ conjugated dienes, such as 1,3-butadiene and isoprene. The said monomers usually form the main monomers, which, based on the total amount of monomer, add up to a proportion of more than 50 wt %, and preferably more than 80 wt %. As a general rule, these monomers show not more than medium to poor solubility in water under standard conditions [20° C., 1 bar (absolut)].

Monomers showing improved water solubility under the aforementioned conditions are those containing either at least one acid group and/or its corresponding anion or at least one amino, amido, ureido or N-heterocyclic group and/or its ammonium derivatives protonated or alkylated on the nitrogen atom. As examples thereof there may be mentioned α,β-monoethylenically unsaturated mono- and di-carboxylic acids and their amides, such as acrylic acid, methacrylic acid, maleic acid, fumaric acid, itaconic acid, acrylamide and methacrylamide, also vinylsulfonic acid, 2-acrylamido-2-methylpropanesulfonic acid, styrenesulfonic acid and water-soluble salts thereof, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolinon-2-yl)ethyl methacrylate. Normally the aforementioned monomers are present merely in the form of modifying monomers in a concentration of less than 10 wt %, and preferably less than 5 wt %, based on the total amount of monomer.

Monomers which usually increase the structural strength of the filmed polymer matrix normally have at least one epoxy, hydroxyl, N-methylol or carbonyl group or at least two non-conjugated ethylenically unsaturated double bonds. Examples thereof are monomers having two vinyl groups, monomers having two vinylidene groups and monomers having two alkenyl groups. Particularly advantageous here are the diesters of dihydroxylic alcohols with α,β-monoethylenically unsaturated monocarboxylic acids, of which acrylic acid and methacrylic acid are particularly preferred. Examples of such monomers having two non-conjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate, and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and divinyl benzene, vinyl methacrylate, vinyl acrylate, allyl methacrylate, allyl acrylate, diallyl maleate, diallyl fumarate, methylene bisacrylamide, cyclopentadienyl acrylate, triallyl cyanurate, and triallylisocyanurate. Particularly significant in this context are, in addition, the C₁-C₈ hydroxyalkyl (meth)acrylates such as n-hydroxyethyl, n-hydroxypropyl or n-hydroxybutyl (meth)acrylates and also compounds such as diacetone acrylamide and acetylacetoxyethyl (meth)acrylate. Frequently the aforementioned monomers are used in a concentration of not more than 10 wt %, and preferably less than 5 wt %, based on the total amount of monomer.

Aqueous polymer dispersions which can be produced by the process of the invention in a particularly advantageous manner are those in which the polymers contain, in the form of polymerized units,

| | |
|---|---|
| 50 to 99,9 wt % | esters of acrylic and/or methacrylic |
| | acids with alkanols containing from 1 to |
| | 12 carbons and/or styrene, or |
| 50 to 99,9 wt % | styrene and/or butadiene, or |
| 50 to 99,9 wt % | vinyl chloride and/or vinylidene |
| | chloride, or |
| 40 to 99,9 wt % | vinyl acetate, vinyl propionate |
| | and/or ethylene. |

In particular, the process of the invention is capable of producing aqueous polymer dispersions whose polymers contain, in the form of polymerized units,

| | |
|---|---|
| 0.1 to 5 wt % | α,β-monoethylenically unsaturated |
| | monocarboxylic and/or dicarboxylic acids |
| | containing at least 3 to 6 carbon |
| | atoms and/or their amides and |
| 50 to 99,9 wt % | at least one ester of acrylic and/or |
| | methacrylic acids with alkanols |
| | containing from 1 to 12 carbon atoms |
| | and/or styrene, or |
| 0.1 to 5 wt % | α,β-monoethylenically unsaturated |
| | monocarboxylic and/or dicarboxylic acids |
| | containing at least from 3 to 6 carbon |
| | atoms and/or their amides and |
| 50 to 99,9 wt % | styrene and/or butadiene, or |
| 0.1 to 5 wt % | α,β-monoethylenically unsaturated |
| | monocarboxylic and/or dicarboxylic acids |
| | containing at least from 3 to 6 carbon |
| | atoms and/or their amides and |
| 50 to 99,9 wt % | vinyl chloride and/or vinylidene |
| | chloride, or |
| 0.1 to 5 wt % | α,β-monoethylenically unsaturated |
| | monocarboxylic and/or dicarboxylic acids |
| | containing at least from 3 to 6 carbon |
| | atoms and/or their amides and |
| 40 to 99,9 wt % | vinyl acetate, vinyl propionate and/or |
| | ethylene. |

The process of the invention is usually carried out in the presence of from 0.1 to 5 wt %, preferably from 0.1 to 4 wt %, and more preferably from 0.1 to 3 wt %, based on the total amount of monomer, of a free-radical polymerization initiator (free radical initiator). Suitable free-radical initiators are any of those capable of initiating free-radical aqueous emulsion polymerization. These may be, basically, peroxides or azo compounds. Of course, redox initiator systems are also suitable. The peroxides used can be any inorganic peroxides, such as hydrogen peroxide or peroxodisulfates, for example, the mono- or di-alkali metal salts or ammonium salts of peroxodisulfuric acid, such as its monosodium, disodium, monopotassium, dipotassium, or ammonium salts, or organic peroxides, such as alkyl hydroperoxides, for example, tert-butyl, p-menthyl, or cumyl hydroperoxide, and also dialkyl or diaryl peroxides, such as di-tert-butyl or dicumyl peroxide. The azo compounds used are mainly 2,2′-azobis(isobutyronitrile), 2,2′-azobis(2,4-dimethylvaleronitrile), and 2,2′-azobis(amidinopropyl) dihydrochloride (AIBA, corresponding to V 50, sold by Wako Chemicals). The aforementioned peroxides are mainly suitable for use as oxidizing agents in redox initiator systems. Appropiate reducing agents which may be used are sulfur compounds having a low level of oxidation, such as alkali-metal sulfites, for example potassium and/or sodium sulfite, alkali-metal hydrogensulfites, for example potassium and/or sodium hydrogensulfite, alkali-metal metabisulfites, for example potassium and/or sodium metabisulfite, formaldehyde sulphoxylates, for example potassium and/or sodium formaldehyde sulfoxylate, alkali-metal salts, specifically potassium and/or sodium salts of aliphatic sulfinic acids and alkali-metal hydrogensulfides, such as potassium and/or sodium hydrogensulfide, salts of multivalent metals, such as iron(II) sulfate, iron(II) ammonium sulfate, iron(II) phosphate, enediols, such as dihydroxymaleic acids, benzoin and/or ascorbic acid and also reducing saccharides, such as sorbose, glucose, fructose and/or dihydroxy acetone.

An essential feature is that some or all of the free radical initiator can be placed in the polymerization vessel prior to commencement of polymerization. Alternatively, it is possible to feed some or all of the free radical initiator during polymerization either batchwise or using a continuous or discontinuous stream of matter. Usually, the free radical initiator is directly metered into the polymerization vessel.

Within the scope of the process of the invention, there are normally also used dispersants which keep both the monomer droplets and the polymer particles dispersed in the aqueous phase and thus maintain stability of the aqueous polymer dispersion produced. Suitable agents for this purpose are the protective colloids and emulsifiers conventionally used for the execution of free-radical aqueous emulsion polymerizations.

Suitable protective colloids are for example polyvinyl alcohols, cellulose derivatives or vinyl pyrrolidone-containing copolymers. A detailed description of other suitable protective colloids is given in Houben-Weyl, Methoden der organischen Chemie, Vol. XIV/1, Makromolekulare Stoffe, pages 411 to 420, Georg-Thieme-Verlag, Stuttgart, 1961. Of course, mixtures of emulsifiers and/or protective colloids may be used, if desired. Preferably the dispersants used comprise exclusively emulsifiers, whose relative molecular weights, unlike those of protective colloids, are usually below 1000. They can be of an anionic, cationic, or non-ionic nature. Of course, when use is made of mixtures of surfactants, the constituents have to be compatible with each other, which can be checked if necessary by a few preliminary tests. Generally, anionic emulsifiers are compatible with each other and with non-ionic emulsifiers. The same applies to cationic emulsifiers, whilst anionic and cationic emulsifiers are not usually compatible with each other. Commonly used emulsifiers are, eg, ethoxylated mono-, di-, and tri-alkylphenols (containing C₄-C₁₂ alkyl; degree of ethoxylation: 3 to 50), ethoxylated fatty alcohols (degree of ethoxylation: 3 to 50; alkyl group: C₈-C₃₆) and also alkali-metal and ammonium salts of alkyl sulfates (containing C₈-C₁₂ alkyl), of sulfuric acid half-esters of ethoxylated alkanols (containing C₁₂-C₁₋₈ alkyl; degree of ethoxylation: 4 to 30), and ethoxylated alkyl phenols (containing C₄-C₁₂ alkyl; degree of ethoxylation: 3 to 50), of alkylsulfonic acids (containing C₁₂-C₁₋₈ alkyl) and of alkylarylsulfonic acids (containing C₁₂-C₁₈ alkyl). Other suitable emulsifiers are given in Houben-Weyl, Methoden der organischen Chemie, Vol XIV/1, Makromolekulare Stoffe, pages 192 to 208, Georg-Thieme-Verlag, Stuttgart, 1961.

Other suitable surfactants have been found to be compounds of the general formula I

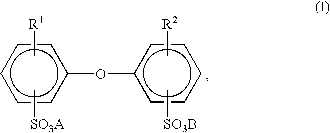

in which R¹ and R² denote C₄-C₂₄ alkyl and one of the radicals R¹ and R² may also stand for hydrogen, and A and B can be alkali-metal ions and/or ammonium ions. In formula I, R¹ and R² preferably denote hydrogen atoms or linear or branched alkyl groups containing from 6 to 18 carbons or containing, in particular, 6, 12 or 16 carbons, whilst R¹ and R² are not both hydrogen atoms. A and B are preferably sodium, potassium or ammonium ions, sodium ions being particularly preferred. Compounds I in which A and B are sodium ions, R¹ is a branched alkyl group containing 12 carbons and R² is a hydrogen atom or R¹ are particularly advantageous. Frequently industrial mixtures are used which contain from 50 to 90 wt % of the monoalkylated product, for example Dowfax® 2A1 (trade name of Dow Chemical Company). Compounds I are well known, eg from U.S. Pat. No. 4,269,749, and are commercially available.

The aforementioned dispersants are, of course, entirely suitable for execution of the process of the invention. The process of the invention is also suitable, however, for synthesis of aqueous polymer dispersions from self-emulsifying polymers in which monomers exhibiting ionic groups cause stabilization by reason of repulsion of charges of like sign.

Non-ionic and/or anionic dispersants are preferably used in the process of the invention. However, cationic dispersants can be used, if desired.

The amount of dispersant used is usually from 0.1 to 5 wt % and preferably from 1 to 3 wt %, based on the total amount of the monomers to be submitted to free-radical polymerization. It is frequently advantageously when some or all of the dispersant is fed to the fluid reaction medium prior to initiation of free-radical polymerization. Furthermore, some or all of the dispersant can be fed, during polymerization, to the reaction medium in the external loop advantageously together with the monomer or monomers, particularly in the form of an aqueous monomer emulsion.

Free-radical chain-transferring compounds are usually employed in order to reduce or control the molecular weight of the polymers obtained by free-radical aqueous emulsion polymerization. Suitable compounds are, substantially, aliphatic and/or araliphatic halo compounds, such as n-butyl chloride, n-butyl bromide, n-butyl iodide, dichloromethane, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary, or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as phenylthiol, ortho-, meta-, or para-methylphenylthiol, and also all of the other sulfur compounds described in Polymer-Handbook 3^{rd} Edition, 1989, J. Brandrup and E. H. Immergut, John Wiley & Sons, section II, pages 133 to 141, or alternatively aliphatic and/or aromatic aldehydes, such as acetaldeyhde, propionaldehyde, and/or benzaldehyde, unsaturated fatty acids, such as oleic acid, dienes having non-conjugated double bonds, such as divinylmethane or vinylcyclohexane, or hydrocarbons containing readily abstractable hydrogen atoms, such as toluene. Alternatively, it is possible to use mixtures of the aforementioned free-radical chain-transfering compounds which are compatable with each other.

The total amount the free-radical chain-transfering compounds optionally used in the process of the invention, based on the total amount of monomers to be polymerized, is usually ≦5 wt %, often ≦3 wt % and frequently ≦1 wt %.

It is advantageous when some or all of the optionally used free-radical chain-transfering compound is fed to the reaction medium prior to initiation of the free-radical polymerization. Furthermore, some or all of the free-radical chain-transferring compound can be fed to the fluid reaction medium, advantageously together with the monomer or monomers, particularly in the form of an aqueous monomer emulsion, while polymerization takes place in the external loop.

Apart from this no-seed method, the emulsion polymerization may be carried out by the seed latex process or in the presence of a seed latex formed in situ, for setting the size of the polymer particles. Relevant processes are known and are disclosed in the prior literature (cf, for example, EP-B 40,419, EP-A 567,812, EP-A 614,922 and also “Encyclopedia of Polymer Science and Technology”, Vol. 5, page 847, John Wiley & Sons Inc., New York, 1966). Thus the prior art recommends, for the inflow process, initially placing a specific finely divided seed polymer dispersion in the polymerization vessel and then polymerizing the monomer or monomers in the presence of the seed latex. In this case the seed polymer particles act as “polymerization neuclei” and decouple the formation of polymer particles and the growth of polymer particles. During emulsion polymerization, further seed dispersion can be added, either by feeding it directly into the polymerization vessel or by adding it to the fluid medium pumped through the external loop. By this means broad size distributions of the polymer particles are achieved, these being frequently desirable particularly in the case of polymer dispersions having a high solids content (cf, for example, DE-A 4,213,965). Instead of adding a specific seed latex, the latter can be formed in situ. To this end, for example, a portion of at least one monomer and a portion of the free radical initiator are used as initial batch together with some or all of the emulsifier and then heated to the reaction temperature to give a relatively finely divided seed. The actual polymerization is then carried out in the same polymerization vessel by the inflow process (cf also DE-A 4,213,965).

The reaction temperature for the process of the invention is suitably a temperature in the range of from 0° to 170° C.; however, temperatures of from 70° to 120° C., preferably from 80° to 100° C., and more preferably from >85° to 100° C. are preferably used. The free-radical aqueous emulsion polymerization can be carried out under a pressure of less than, equal to, or greater than 1 bar (absolute) so that the polymerization temperature can exceed 100° C. and may be up to 170° C. Preferably highly volatile monomers such as ethylene, butadiene or vinyl chloride are polymerized at elevated pressure. The pressure used may be 1.2, 1.5, 2, 5, 10, 15 bar or even higher. If emulsion polymerizations are carried out in vacuo, pressures of 950 mbar, frequently 900 mbar and often 850 mbar (absolute) are used. Advantageously, free-radical aqueous emulsion polymerization is carried out under a blanket of inert gas such as nitrogen or argon under a pressure of 1 bar (absolute).

Following the polymerization reaction, it is usually necessary to remove odoriphores, such as residual monomers and other organic volatile constituents, from the aqueous polymer dispersion produced in the present invention. This can be done in known manner by physical means comprising distillation (particularly steam distillation) or scrubbing with an inert gas. Reduction of the content of residual monomers can also be effected chemically by free-radical post-polymerization, particularly under the action of redox initiator systems, such as are mentioned in, say, DE-A 4,435,423, DE-A 4,419,518, and DE-A 4,435,422, this being carried out before, during, or after processing by distillation. Particularly suitable oxidizing agents for the redox-initiated post-polymerization are hydrogen peroxide, tert-butyl hydroperoxide, cumene hydroperoxide, or alkali-metal peroxodisulfates. Suitable reducing agents are sodium disulfite, sodium hydrogensulfite, sodium dithionite, sodium hydroxymethane sulfinate, formamidinosulfinic acid, acetone bisulfite (=addition product of sodium hydrogensulfite and acetone), ascorbic acid or reductively effective sugar compounds. Post-polymerization using the redox initiator system is carried out at temperatures ranging from 10° to 100° C. and preferably from 20° to 90° C. The oxidation-reduction pair can be added to the aqueous dispersion independently, either in one lot, in portions or continuously, over a period of 10 minutes to 4 hours. Improvement of the post-polymerizing efficiency of the redox initiator systems can be achieved by adding soluble salts of metals of different valences, such as iron, copper or vanadium salts, to the dispersion. Frequently complexers are also added, which keep the metallic salts in solution under the conditions of the reaction.

Frequently, the resulting aqueous polymer dispersion is finally neutralized with a low-odor base, preferably with alkali metal or alkaline earth metal hydroxides, alkaline earth metal oxides, or non-volatile amines. The non-volatile amines include, in particular, ethoxylated diamines or polyamines such as are commercially available under the tradename Jeffamine (sold by Texaco Chemical Co.), for example. Preferably, however, neutralization is effected using aqueous caustic soda or potash.

The resulting aqueous polymer dispersion usually has a content of solid polymer of ≧1 wt % and ≦80 wt %, frequently ≧20 wt % and ≦70 wt % and often ≧30 wt % and ≦60 wt %, always based on the aqueous polymer dispersion. The number-average particle diameter determined by quasi-elastic light scattering (ISO Standard 13,321) is usually between 10 and 2000 nm, frequently between 20 and 1000 nm, and often between 100 and 700 nm.

The aqueous polymer dispersions obtained using the process of the invention are, on completion of the aftertreatment, almost completely free from solvents, monomers, or other volatile constituents and are thus low-odor, low-emmision products. The polymer dispersion of the invention is suitable for the production of low-emission and solventless coating compositions, such as plastics emulsion plasters, coating compositions or paints and, in particular, low-emission emulsion paints, and sealing compositions and adhesives.

The process of the invention reduces the formation of polymer deposits on the metallic surfaces of the polymerization vessel, baffles therein, pipes, and the heat exchanger, by which means cleaning can be carried out at greater intervals. Furthermore, the introduction of at least one monomer into the external loop means that a major portion of the mixing work is carried out in the external loop, which in turn allows for a reduction of the speed of rotation of the stirrer in the polymerization vessel and a consequent reduction in the formation of so-called shear-induced coagulate.

The invention is illustrated in detail below with reference to non-restrictive examples.

### EXAMPLES

Analysis

The number-average particle diameter of the polymer particles was determine by dynamic light scattering on a 0.005 to 0.01 wt % strength aqueous dispersion at 23° C. using an Autosizer IIC, sold by Malvern Instruments, England. The value given is the average diameter of the cumulant z-average of the measured autocorrelation function (ISO Standard 13,321).

The solids contents were determined by drying an aliquot for 6 hours at 140° C. in a drying oven. Two separate readings were taken in each case. The value given in the examples is the average of the two readings.

The amounts of coagulate were determined by filtration through sieves having mesh sizes of 125 μm and 45 μm respectively. This was done by filtering the aqueous polymer dispersion first through the 125 μm sieve and then through the 45 μm sieve at from 20° to 25° C. (ambient temperature). Both sieves were weighed prior to filtration. Following filtration, the sieves were rinsed with a little deionized water and then dried in a drying oven at 100° C. under atmospheric pressure to constant weight. After cooling to ambient temperature, the sieves were reweighed. The content of coagulate was calculated from the difference between the individual weighings (sum of the weighings of the 125 μm and 45 μm sieves), based on the filtered amount of aqueous polymer dispersion.

### Example 1

Use was made of a polymerization vessel having a capacity of 4 L and equipped with an anchor agitator, reflux condenser, and pipe connections in the lid of the polymerization vessel, and an external loop. The point of withdrawal of the external loop was situated in the base, and the point of influx in the lid, of the polymerization vessel. The external loop also contained a flow inducer and a cylindrical mixing cell, into which the monomer emulsion was metered. Mixing in the mixing cell was carried out with a cylindrical rotor at 2000 revolutions per minute. The inside diameter of the mixing cell was 44 mm and its inside length 50 mm. The outside diameter of the cylindrical rotor was 40 mm and its length 48 mm.

In the polymerization vessel there were initially placed, at room temperature

597 g deionized water and

68 g an aqueous polystyrene seed latex (polymer solids content 33 wt %, number-average particle diameter 30 nm)

and the mixture was heated to 85° C. with stirring (60 rpm) under atmospheric pressure. 6 g of feed stream 3 were then added via a feed pipe in the lid of the polymerization vessel and the pump in the external loop was switched on. The amount pumped through the external loop was 4 liters per hour. Following a period of 5 minutes, metering of feed stream 1 into the mixing cell was started at the same time as the feed of the remainder of feed stream 3 through the feed pipe. Feed stream 1 was continuously added over a period of 120 minutes and the remainder of feed stream 3 continuously added over a period of 165 minutes. Immediately on completion of feed stream 1, the total amount of feed stream 2 was continuously metered into the mixing cell over a period of 45 minutes. On completion of the two feed streams, the reaction was allowed to continue for a period of 60 minutes at the reaction temperature with continued stirring, after which the aqueous polymer dispersion was cooled to room temperature. A pH of 7.5 was established with a 10 wt % strength aqueous solution of potassium hydroxide. The resulting aqueous polymer dispersion had a solids content of 49.8 wt %. The number-average particle diameter was 128 nm. The coagulate content determined with the 125 μm sieve was found to be 35 ppm and that determined with the 45 μm sieve to be 40 ppm.

| Feed 1: | | |
|---|---|---|
| 320 | g | deionized water |
| 142 | g | 15 wt % strength aqueous solution of sodium lauryl |
| | | sulfate |
| 542 | g | n-butyl acrylate |
| 503 | g | methyl methacrylate |
| 10 | g | acrylic acid |
| Feed 2: | | |
| 150 | g | deionized water |
| 27 | g | 15 wt % strength aqueous solution of sodium lauryl |
| | | sulfate |
| 28 | g | n-butyl acrylate |
| 373 | g | methyl methacrylate |
| 12 | g | acrylic acid |
| Feed 3: | | |
| 3.0 | g | sodium peroxodisulfate |
| 57 | g | deionized water |

### Comparative Example 1

The synthesis described in Example 1 was repeated except that feed streams 1 and 2 were fed to the polymerization vessel not via the mixing cell but directly through a separate feed pipe in the lid.

The resulting aqueous polymer dispersion had a solids content of 49.5 wt %. The number-average particle diameter was 124 nm. The coagulate content determined with the 125 μm sieve was found to be 230 ppm and that determined with the 45 μm sieve to be 200 ppm.

### Comparative Example 2

The synthesis described in Comparative Example 1 was repeated except that the stirrer speed was not 60 rpm but 150 rpm.

The resulting aqueous polymer dispersion had a solids content of 49.7 wt %. The number-average particle diameter was 126 nm. The coagulate content determined with the 125 μm sieve was found to be 140 ppm and that determined with the 45 μm sieve to be 180 ppm.

### Example 2

In the polymerization apparatus described in Example 1 there were placed, at room temperature,

| | | |
|---|---|---|
| 539 | g | deionized water and |
| 28 | g | an aqueous polystyrene seed latex (polymer solids |
| | | content 33 wt %, number-average particle diameter |
| | | 30 nm) |

and the mixture was heated to 85° C. with stirring (60 rpm) under a blanket of nitrogen. Then 17 g of feed stream 2 were added through a feed pipe and the pump in the external loop was switched on. The amount pumped through the external loop was 4 liters per hour. Following a period of 5 minutes, metering of feed stream 1 into the mixing cell was started at the same time as the feed of the remainder of feed stream 2 through the feed pipe. The feed streams 1 and 2 were continuously added over a period of 180 minutes. On completion of the two feeds, the reaction was allowed to continue with stirring for a further 60 minutes at the reaction temperature, after which the aqueous polymer dispersion was cooled to room temperature. A pH of 7.5 was established with a 10 wt % strength aqueous solution of potassium hydroxide. The resulting aqueous polymer dispersion had a solids content of 51.7 wt %. The number-average particle diameter was 170 nm. The coagulate content determined with the 125 μm sieve was found to be 20 ppm and that determined with the 45 μm sieve to be 52 ppm.

| Feed 1: | | |
|---|---|---|
| 450 | g | deionized water |
| 145 | g | 15 wt % strength aqueous solution of sodium lauryl |
| | | sulfate |
| 840 | g | n-butyl acrylate |
| 560 | g | styrene |
| 42 | g | acrylamide |
| 21 | g | acrylic acid |
| Feed 2: | | |
| 4.2 | g | sodium peroxodisulfate |
| 164 | g | deionized water |

### Comparative Example 3

The synthesis described in Example 2 was repeated except that feed stream 1 was fed directly into the polymerization vessel, ie not via the mixing cell but through a separate feed pipe.

The resulting aqueous polymer dispersion had a solids content of 51.3 wt %. The number-average particle diameter was 171 nm. The coagulate content determined with the 125 μm sieve was found to be 305 ppm and that determined with the 45 μm sieve to be 215 ppm.

### Comparative Example 4

The synthesis described in Comparative Example 3 was repeated except that the stirrer speed was not 60 rpm but 150 rpm.

The resulting aqueous polymer dispersion had a solids content of 51.4 wt %. The number-average particle diameter was 168 nm. The coagulate content determined with the 125 μm sieve was found to be 25 ppm and that determined with the 45 μm sieve to be 98 ppm.

1. A process for the production of an aqueous polymer dispersion by aqueous free-radical emulsion polymerization of at least one ethylenically unsaturated compound (monomer) in a polymerization vessel, which has an external loop leading from, and back to, the polymerization vessel, wherein
a) some or all of the water is placed in the polymerization vessel as initial batch,
b) the fluid medium present in the polymerization vessel is transported away from the polymerization vessel and recycled thereto through the external loop during polymerization and
c) at least a portion of at least one monomer is metered into the fluid medium that is transported through the external loop during polymerization.

2. A process as defined in claim 1, wherein some or all of
a dispersant,
a seed latex,
a free radical initiator and/or
a portion of
at least one monomer
is placed in the polymerization vessel as initial batch.

3. A process as defined in claim 1 or claim 2, wherein the fluid medium in the external loop is transported by means of a pump.

4. A process as defined in claim 3, wherein the monomer or monomers are metered into the fluid medium on the suction side of the pump.

5. A process as defined in any of claims 1 to 4, wherein the monomer or monomers are metered into the fluid medium in the form of an aqueous monomer emulsion.

6. A process as defined in any of claims 1 to 5, wherein the external loop contains one or more heat exchangers and/or mixing devices.

7. An aqueous polymer dispersion whenever obtained by a process as defined in any of claims 1 to 6.

8. A method of using an aqueous polymer dispersion as defined in claim 7 as a component of adhesives, sealing compositions, plastics plasters, coating compositions, and paints.

9. A contrivance, comprising
a polymerization vessel,
a contrivance I which enables fluid medium to be withdrawn from the polymerization vessel and recycled thereto at a site which differs from the point of withdrawal and
a contrivance II which enables the monomer or monomers to be introduced into the fluid medium present in contrivance I.
